(19) United States
(12) Patent Application Publication
(10) Pub. No.: US 2004/0138068 A1
(43) Pub. Date: Jul. 15, 2004

(54) Method For Providing Treatment Chemicals In A Subterranean Well

(75) Inventors: Brett Rimmer, Sugar Land, TX (US); Alan Saxon, York (GB); Francisco Fragachan, Barcelona (ES)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(73) Assignee: SCHLUMBERGER TECHNOLOGY CORPORATION, Sugar Land, TX (US)

(21) Appl. No.: 10/707,534

(22) Filed: Dec. 19, 2003

Related U.S. Application Data
(60) Provisional application No. 60/435,150, filed on Dec. 19, 2002.

(51) Int. Cl. C09K 7/06

(52) U.S. Cl. 507/100

(57) ABSTRACT

It is proposed a method of delivering chemicals such as scale inhibitor into a wellbore producing fluids including providing the chemicals, in a slow-released form, through a container located in the path of the production fluids so that the production fluids pass through the container. Preferably, the container is suspended to the production tubing and periodically retrieved out of the well to be refilled.

### CROSS REFERENCE TO RELATED APPLICATIONS

This patent application claims the priority of provisional application 60/435,150, filed on Dec. 19, 2002.

### TECHNICAL FIELD OF THE INVENTION

This invention relates to an apparatus and methods for providing treatment chemicals in a subterranean formation. More particularly, the invention relates to methods of ensuring permanent treatment of wells. Such treatments are particularly useful at inhibiting the formation of scales.

Concurrently with production fluids such as crude oil, dissolved salts are typically produced which form mineral deposits or scales such as barium sulfate, strontium sulfate, calcium sulfate and calcium carbonate. These mineral deposits tend to reduce the effective diameter of the production tubing. by pluging them or damageing some valves or other subterranean equipments. Similar problems may occur in injection wells where the injected fluids are typically brines, for instance, constituted by the formerly separated water phase of a produced fluid.

To alleviate the scale problems, various treatments have been developed that include for instance, injecting into the reservoir a solution comprising a scale inhibitor adsorbed onto the rock and later desorbed during fluid production. Different systems have been developed that provide a relatively slow release of the scale inhibitor. Reference is made for instance to U.S. Pat. Nos. 3,827,977, 4,602,683, 5,141,655 and 5,604,185.

However, most current scale inhibition treatments are only effective for a limited period. It is common to repeatedly treat the well every few months. Each treatment requires means such as pumping equipment and/or coiled tubing injectors—for injecting the inhibitor solution and a preflush or afterflush treatment. Even though each cleaning job is relatively simple and constitutes a minimal cost for the oil industry, the repetition of the treatments months after months impedes the profitability of the well.

Another disadvantage of the conventional technologies is that the treatments are often administered or conducted by guesswork. Repeated analysis of the produced fluids are mostly impracticable and hence, would not necessarily provide good information as to the fluids present downhole.

Therefore, it would be desirable to provide less complex method to treat wells. In particular, it would be advantageous to provide a longer term inhibition of scale formations and further provide better ways of assessing the effectiveness of the treatment.

### SUMMARY OF INVENTION

In one embodiment, the invention relates to a method for treating a subterranean formation comprising providing a container located within the production tubing or near the bottomhole extremity of the production tubing, said container filled with at least one chemical and comprising at least an opening.

The invention also relates to a method of replenishing the chemical(s) in the container comprising fishing the container with a fishing tool connected to a slick line, a wireline or a coiled tubing, refilling the container at the surface and replacing it downhole.

### BRIEF DESCRIPTION OF DRAWINGS

FIG. 1 shows a container suspended from a hanger with a nipple having a lock profile.

FIG. 2 shows a retreivable container suspended from an anchor.

FIG. 3 shows a container suspended from a hydraulic wireline set with retractable jaws.

### DETAILED DESCRIPTION

In a preferred embodiment, the container consists of a meshed like basket through which the production fluids will flow. The mesh or other apertures are preferably of relatively high dimension so that the flow of production fluids is not significantly impeded.

The container is preferably suspended near the bottomhole extremity of the production tubing so that at least a large fraction of the production fluids are effectively treated before entering the production tubing.

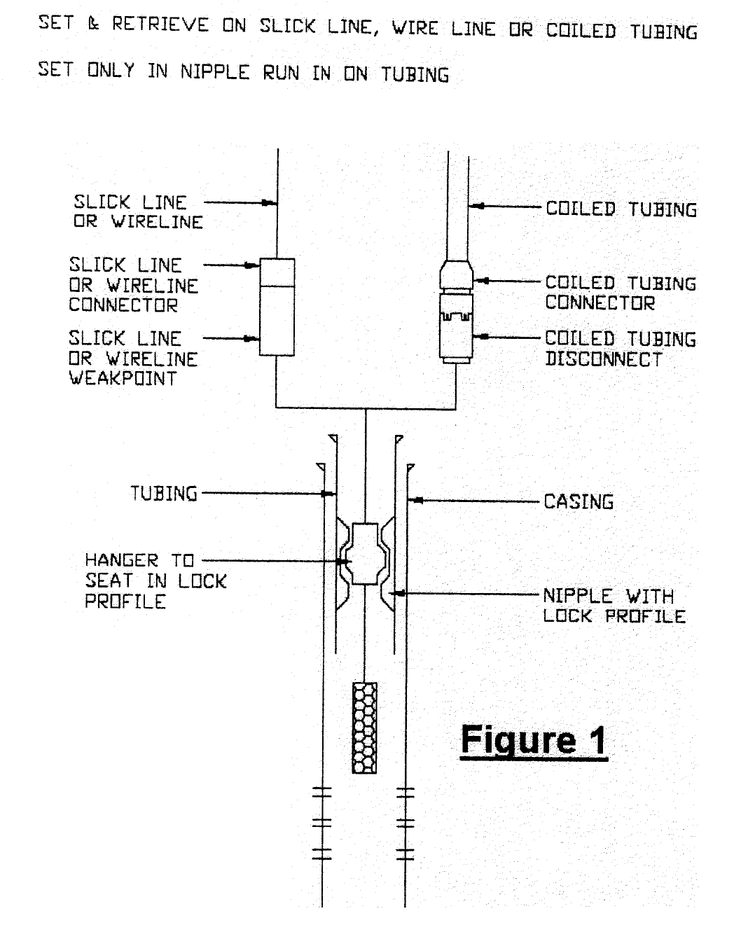

In one embodiment of the invention and as illustrated in FIG. 1, the container is suspended from a hanger seating in a lock profile of a nipple located within the tubing, near its downhole extremity. Advantageously, most tubings are already equipped with such a nipple. In FIG. 1, the well is shown having a casing, which is usually cemented, that ensures zonal isolation and the mechanical integrity of the well. The production fluids are displaced up to the surface through production tubing. In the pay zone, perforations are provided for the formation fluids to enter the well. Similar configurations may be found with injection wells (even if of course, the flow is inversed from surface to the subterranean formation). The hanger is preferably provided with a connection means (here not represented) that allows a secure connection for instance to a slick line or wireline or a coiled tubing though a detent self-locking device, used for locating the basket into the wellbore and retrieving it either at periodical interval or when surface analysis show an increase of the production of scales.

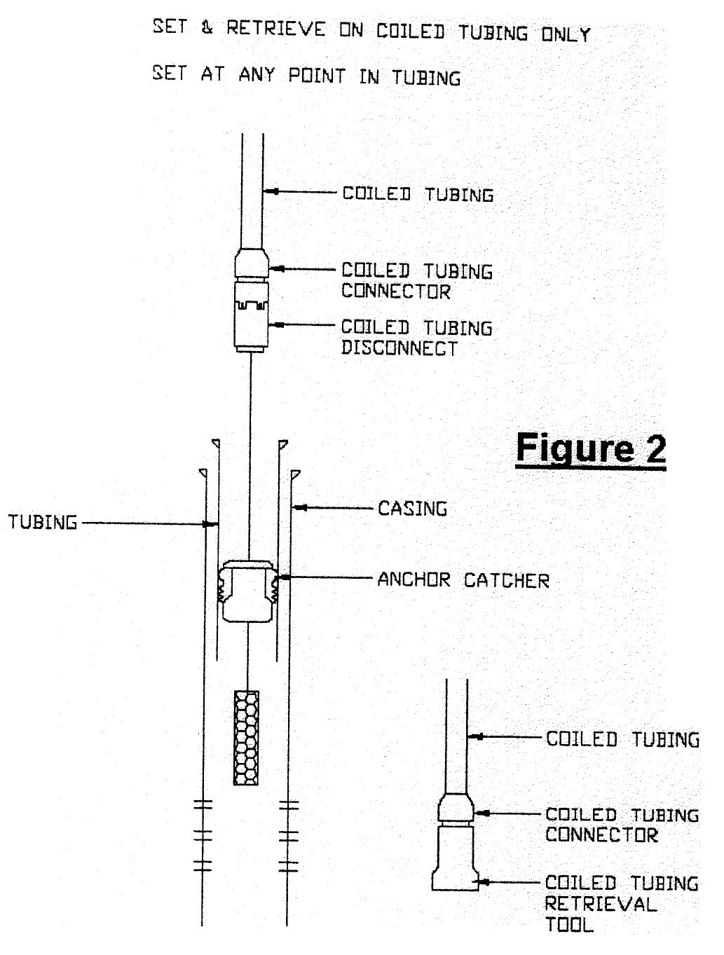

According to another embodiment, and as shown in FIG. 2, the tubing is provided with an anchor catcher and the container is suspended to that anchor set and retrieved when needed through the use of a coiled tubing, wireline, slickline or similar equipment.

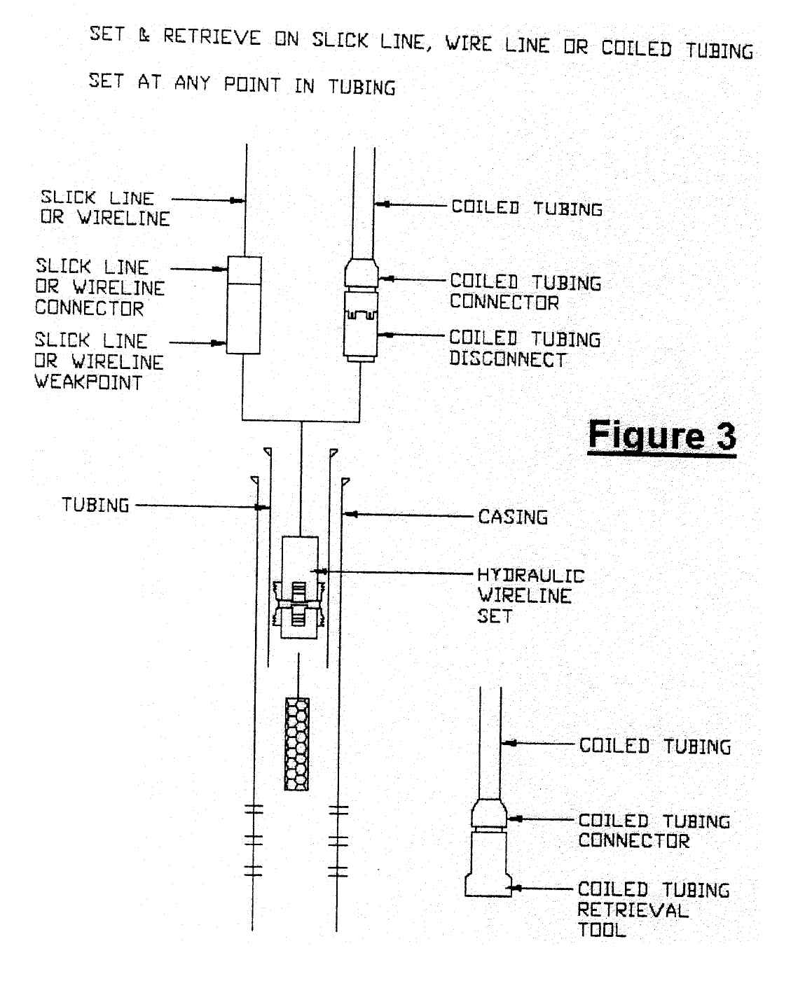

According to a third embodiment, and as shown in FIG. 3, the container is suspended from a hydraulic wireline set comprising retractable jaws. This embodiment makes it possible to adjust the position of the basket at the lower extremity or inside the tubing to ensure a better treatment.

According to fourth embodiment, the container is permanently anchored at the end or into the production tubing and coiled tubing (slickline or similar) is used to refill it. This embodiment is usually not preferred since it does not allow one to assess the release rate of chemicals into the well and therefore, the periodicity of the refill operation may not be accurate.

According to another embodiment, not represented, the container may be introduced into the well by pumping it into the hole (like a pig), and similarly pumping it out. In this later case, the tubing should preferably be equipped with a latch or recess or equivalent mechanism to stop the container in the appropriate location.

The chemicals to be slowly released may be encapsulated within a polymeric enclosure. The enclosure may consist of any polymer that can degrade over a period of time to release said chemicals and will typically be chosen depending on the release rate desired. Degradation of the polymer can occur, for example, by hydrolysis, solvolysis, melting, or other mechanisms.

Preferred polymers are selected from the group consisting of homopolymers and copolymers of glycolate and lactate, polycarbonates, polyanhydrides, polyorthoesters, and polyphosphacenes. Most preferably, said polymer is poly(lactic acid-co-glycolic acid).

The encapsulation may be accomplished by known methods such as double emulsion technique involving the evaporation of a secondary emulsion by freeze drying or other drying method.

The scale inhibitor may also be delivered in the form of porous ceramic particles such as the ones described in WO99/36668 hereby included by reference. Another method for making porous particles suitable to introduce chemicals into a well is also known from U.S. Pat. No. 5,893,416 and U.S. Pat. No. 5,964,291 also included by reference.

A large variety of scale inhibitors are available commercially. Most of the commercialized scale inhibitors contain several reactive groups (carboxylate and/or phosphonate) which are capable of interacting with polyvalent metal ions to prevent scale deposits. Examples of inhibitors include a polycarboxylate, (homo or copolymer of an ethylenically unsaturated acid monomer such as acrylic acid, methacrylic acid, maleic acid, itaconic acid, fumaric acid, mesoconic acid, citraconic acid and the like), monoesters of diacids with alkanols, e.g., having 1-8 carbon atoms, and mixtures thereof. Monomeric and polymeric phosphonates, e.g., aminomethylenephosphonates and homopolymers and copolymers of vinylphosphonate. Another class of inhibitors which may be used in practicing the method of this invention are organic phosphate esters such as phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine.

Though the invention is preferably used for delivering scale inhibitor, the same equipment and method of replenishing it can be used for other type of chemicals. For instance, several containers may be located near distinct perforation areas and a distinct chemical marker (for instance a dye) may be provided in each container. This provides an easy way to identify producing and non-producing areas. In that later case, a string of containers may be used, all anchored to one single seat.

1. A method of delivering a chemical into a wellbore comprising providing the chemical in a slow-released form, introducing the chemical in a container having an opening and locating the container in the path of the production fluids.

2. The method of claim 1, wherein the container is a meshed-like basket.

3. The method of claim 1, wherein the container is located in the wellbore by pumping it.

4. The method of claim 1, in which the producing fluids are flowing from the subterranean formation to the surface through a production tubing and wherein the container is placed near the extremity of the production tubing.

5. The method of claim 3, wherein the container is suspended to a hanger located in the production tubing.

6. The method of claim 4, wherein the production tubing is provided with a nipple.

7. The method of claim 4, wherein the production tubing is providing with an anchoring means.

8. The method of claim 1, further comprising removing the container from the wellbore, refilling it and relocating the refilled container in the wellbore.

9. The method of claim 7, wherein the container is attached to fishing tool connected to a wellbore tool selected from the group consisting of slick line, wireline and coiled tubing.

10. The method of claim 1, wherein said chemical is a scale inhibitor.

11. The method of claim 9, wherein said scale inhibitor is selected from the group consisting of a carboxylate, phosphonates and mixtures thereof.

12. The method of claim 9, wherein said scale inhibitor is an organic phosphate ester.

13. The method of claim 1, wherein said chemical is encapsulated.

14. The method of claim 12, wherein said chemical is encapsulated in a polymer selected from the group consisting of homopolymers and copolymers of glycolate and lactate, polycarbonates, polyanhydrides, polyorthoesters, and polyphosphacenes.

15. The method of claim 13, wherein said polymer is poly(lactic acid-co-glycolic acid).
